(19) United States
(12) Patent Application Publication
(10) Pub. No.: US 2015/0048031 A1
(43) Pub. Date: Feb. 19, 2015

(54) Orifice plate flocculation process

(71) Applicant: Hossein Eshaghi, Pensacola, FL (US)

(72) Inventor: Hossein Eshaghi, Pensacola, FL (US)

(21) Appl. No.: 13/987,627

(22) Filed: Aug. 16, 2013

(51) Int. Cl. C02F 1/52

(52) U.S. Cl. CPC C02F 1/52
USPC 210/738

(57) ABSTRACT

In the water treatment industry, the present mechanical flocculation systems and over/under or channel side to side static flocculation systems have been utilized. These static flocculation systems are inefficient and require additional head loss and also require more basin volumes to produce a good flocculation. The mechanical flocculation systems use power and are subject to oil leak to drinking water sources. The orifice plate flocculation is an innovative technology in water treatment flocculation process that is more efficient, operator friendly, and requires less capital cost. The orifice plate flocculation system can also increase the flocculation capacities of existing mechanical flocculation basins up to 100% without any additional basin.

There is not any federally sponsored research related to this invention.

### DESCRIPTION

1. Related Application

The present application is based on, and claims priority from, U.S. patent application Ser. No. 12,928,926, filed Dec. 23, 2010, the disclosure of which is hereby incorporated by reference herein in its entirety. That application was for a 3-stage orifice plate flocculation process and this Continuation in Parts application is for an improved 4, 5 or up to 6 stage orifice plate flocculation process.

2. Background

See the attached Confidential Proprietary Information, invention disclosure Form dated Oct. 20, 2010 for the background information, the prior problems at the subject facility and resolutions.

Prior Arts—In the water treatment industry, the most common flocculation systems are mechanical flocculation system and over/under or channel side to side static flocculation systems. The over/under or channel side to side flocculation systems are inefficient and require additional head loss and also require more basin volumes to produce a good flocculation process. The mechanical flocculation system requires drives that use power and are limited in providing multi-stage mixing zones unless multi drives (more power usage) are provided. The mechanical drives are also subject to replacement cost due to the mechanical failure and oil leak to the drinking water sources and they require some daily operation and maintenance. A search of the USPTO's website did not reveal any other arts similar to orifice plate flocculation system for water treatment process.

### TECHNICAL FIELD

Create a hydraulic flocculation process that is an effective green technology, static, non-mechanical driven and does not require operation and maintenance by plant operator as well as no future need for replacement.

### SUMMARY OF INVENTION

The orifice plate flocculation process uses a static mixing unit with a simple operation, and is an operator friendly device and does not require any operation and maintenance. The orifice plate flocculation process does not have a mechanical drive. The orifice plate flocculation process is a treatment process installed after the chemical additions in a flash mixing unit process in a water treatment setting.

The art of orifice plate flocculation was an idea of replacing the mechanical flocculators with a system containing no moving parts. A series of plates, each containing a number of circular openings (or any shape openings), or ‘orifices’, are placed in the basin with 2′-5′ relatively narrow channels. In this case, water enters the channels and flows through the orifices creating mixing and head loss in downstream. The plate material can be any of non-corrosive material such as 304 stainless steel, fiberglass reinforced plastic, woods, etc. with sufficient strength to stand the head differential forces in the liquid.

A research into the background and theory of the non-mechanical flocculation system turned up only over-under or channel & baffle type flocculators. While these are non-mechanical, the hydraulics of the orifice plate flocculation system will be different. Although many other configurations for hydraulic flocculators may exist, none resembling the orifice plate flocculation process could be located in any reference texts or standards for raw water treatment. Most rely on the more traditional over/under configuration.

Two basic parameters guide the design of a flocculation basin: 1) Velocity gradient (G), or the space rate of change of velocity at any point and 2) Retention time (T), or how long the water resides within the flocculation basin. Conventional flocculation design criteria for a water treatment plant requires an average velocity gradient of 40 to 100 sec⁻¹ with a retention time of around 15-30 minutes to provide a total velocity gradient verses time (GT) ranging from 30,000 to 75,000. The velocity gradient (G) values for the orifice plate flocculation system design for each stage were calculated. These values were consistent with other recommended velocity gradient (G) values. Losses due to friction were calculated but are negligible when compared with the loss through the orifice. The head loss is a factor of orifice area of each plate and flow through orifices. Calculate head-loss for each plate at given flow and add them up for all plates. This overall head loss for each plant will be different based on total velocity gradient verses time (GT) value required for a proper flocculation process.

The Orifice Plate flocculation process design is fairly simple. It consists of a series of plates arranged in channels within the flocculation basin. Each plate has a specific number of circular openings, or ‘orifices’, with each orifice diameter ranging from 4 to 10 inches or larger. The openings are placed to avoid short-circuiting and to induce the proper amount of velocity gradient. See the attached FIG. 1 for a plan view of the orifice plate flocculation system layout. By varying the number of plates, orifice sizes, and the quantity of orifices, the velocity gradient for each “stage” can be controlled. For the orifice plate flocculation process design, the velocity gradient (G) is lessened with each stage which in turn reduces shear, theoretically allowing larger and larger flocs to form by keeping them in suspension without breaking the flocs apart. The stages near the influent have more plates with fewer orifices, while the end stages have fewer plates but the plates have more orifices. Each plate will also have as an example a 1.5′ by 1″ rectangular opening in the bottom for flushing the channel floor and mixing with the upper liquid contents. The design of individual plates with different orifice patterns can be found in the attached FIG. 2. The opening sizes and patterns in FIG. 2 as well as the orifice plate layout shown in FIG. 1 are specially designed for a water plant. The plate width, layout, opening sizes and patterns for other plants have to be designed individually based on the flow, head loss and basin configurations to ensure an adequate flocculation.

Each single plate is a mixing element that is installed a few or several feet apart in a large channel/basin to create velocity gradient (G) for a certain time period (T) between each plate to provide a velocity gradient verses time (GT) value of for example 20,000-25,000 for the first group of plates to be called as the 1^{st} stage (with high velocity gradient) of flocculation; then the 2^{nd} group of plates with more holes (or with larger size openings) for another set of periods/distances between each plate to provide a GT value of for example 18,000-20,000 for the overall 2^{nd} group to be called as 2^{nd} stage (with medium velocity gradient) of flocculation; and the 3^{rd} group of plates with more holes and/or larger openings for another set of periods/distances between each plate to provide a GT value of for example 15,000-18,000 for the overall 3^{rd} group to be called as 3^{rd} stage (with medium low velocity gradient) of flocculation; and the 4^{th} group of plates with more holes and/or larger openings for another set of periods/distances between each plate to provide a GT value of for example 10,000-15,000 for the overall 4^{th} group to be called as 4^{th} stage (with low velocity gradient) of flocculation; and so on for 1 or 2 more stages of lower velocity gradient flocculation.

### BRIEF DESCRIPTION OF DRAWINGS

FIG. 1 shows an example plan view of a 3-stage orifice plate flocculation process in a flocculation basin divided into five 2.5 feet wide by 12 feet deep channels. FIG. 2 shows the example orifice plates with different size openings and patterns for a 3-stage flocculation process. The 4, 5 and 6-Page stage flocculation processes will have more orifice plate holes as compared to the number of holes for the previous stages.

### DETAILED DESCRIPTION OF DRAWINGS

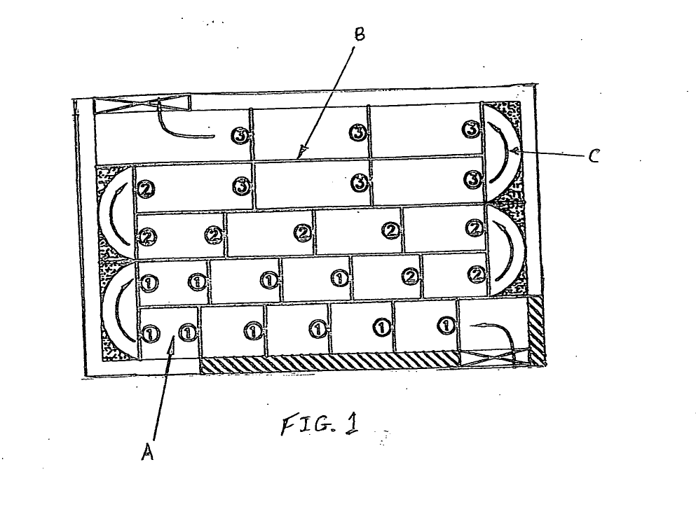

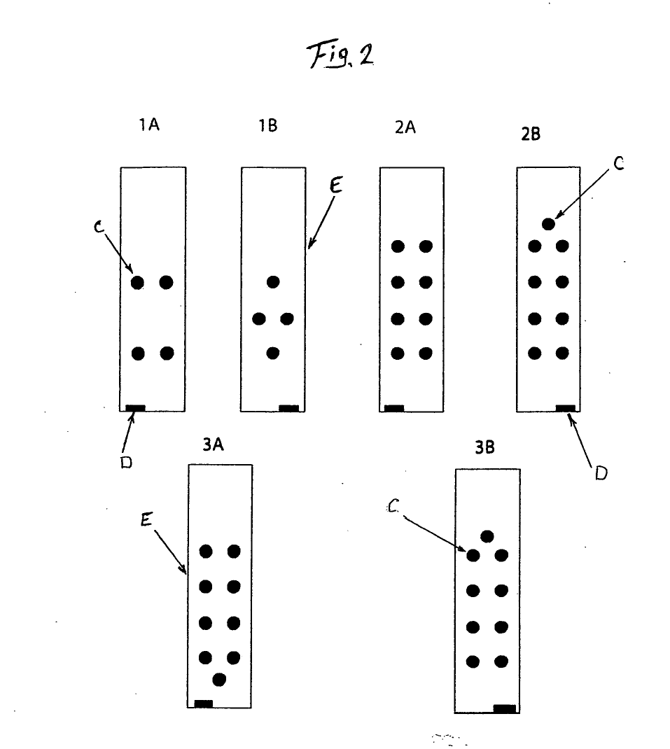

FIG. 1—The flocculation basin at an existing water treatment plant was about 28′ long, 16′ wide and 12′ deep. This drawing shows the flow from is diverted into the flocculation basin divided into several channels with multi mixing stages labeled as Stages 1, 2 and 3. The water from the flocculation basin flows to a typical sedimentation basin in a water treatment plant. The plates in the stages can be, for an example, 12′ deep with a width of 2.8′-3.0′. The Stage 1 plates can be about 3′-4′ apart. The Stage 2 plates can be about 4′-5′ apart. The Stages 3 and 4 plates can be about 6′ and 8′ apart, respectfully, and so on for other stages. The numbering and lettering in FIG. 1 are:
1, 2 and 3 numberings are showing the location of each orifice plate in each stage of the 3-stage flocculation process.
A refers to the flocculation basin.
B refers to baffles used to divide the basin into five channels.
C refers to flow direction in the orifice plate flocculation basin.

FIG. 2—This drawing shows the orifices size, number and patterns for three stages of the six stages. The plates 1A and 1B, each with four (4) 8″ orifices and one (1) 1″ by 1.5′ slot at bottom, are for the Stage 1 and the hole locations are patterned to prevent short circuiting. However, plates 2A and 2B for Stage 2, plates 3A and 3B and subsequent plates 4A through 6B have more orifices and/or larger holes sizes to generate lower velocity gradient (G) values than the velocity gradient (G) value for Stage 1. All plates are equipped with a bottom slot for flushing the channel floor and mixing it with the upper liquid contents. The numbering and lettering in FIG. 2 are:
1A and 1B plates with the same number and size of openings are for the Stage 1 with different holes patterns.
2A and 2B plates with the same number and size of openings are for the Stage 2 with different holes patterns.
3A and 3B plates with the same number and size of openings are for the Stage 1 with different holes patterns.
C refers to the orifices of each plate that is equipped with different number and size or pattern for openings.
D refers to the bottom slot on each plate to scour the channel/basin floor.
E refers to the plates made of a non-corrosive material.

1. (canceled)

2. (canceled)

3. (canceled)

4. (canceled)

5. A water treatment flocculation process utilizing motionless plates equipped with openings each several inches hereby defined as orifice plate flocculation process whereas:
a. Each single orifice plate is a mixing element that is installed a few feet apart in a large flocculation channel or basin to create velocity gradient for a certain time period between each plate to provide a velocity gradient verses time period value sufficient for a proper high velocity gradient flocculation for the first group of plates to be called as the first stage of flocculation process
b. Each single orifice plate with larger size hole openings or more hole openings is a mixing element that is installed several feet apart in a large flocculation channel or basin to create velocity gradient for a certain time period between each plate to provide a velocity gradient verses time period value sufficient for a proper high medium velocity gradient flocculation for the second group of plates to be called as the second stage of flocculation process
c. Each single orifice plate with larger size hole openings or more hole openings is a mixing element that is installed several feet apart in a large flocculation channel or basin to create velocity gradient for a certain time period between each plate to provide a velocity gradient verses time period value sufficient for a proper medium velocity gradient flocculation for the third group of plates to be called as the third stage of flocculation process
d. Each single orifice plate with larger size hole openings or more hole openings is a mixing element that is installed several feet apart in a large flocculation channel or basin to create velocity gradient for a certain time period between each plate to provide a velocity gradient verses time period value sufficient for a proper medium low velocity gradient flocculation for the fourth group of plates to be called as the fourth stage of flocculation process

6. Where the orifice plate flocculation process as claimed in claim 5:
Additional 1 or 2 stages of lower velocity gradient of flocculation process can be provided by varying the hole opening sizes or number of holes as well as longer separations between the orifice plates in each of these additional stages to provide an overall velocity gradient verses time period value of over 40,000 for the entire flocculation process

7. Where the flocculation process as claimed in claim 5:
These orifice plates mixing units can be equipped with 1-inch wide rectangular opening for about ½ of the plate's bottom area to provide cleansing/sweeping action for the floor of the flocculation channels or basins.
